(19) United States
(12) Patent Application Publication
(10) Pub. No.: US 2003/0118276 A1
(43) Pub. Date: Jun. 26, 2003

(54) Optical switch having a retro-reflector associated therewith and a method of use thereof

(75) Inventors: Christopher J. Frye, Orefield, PA (US); Michael Hahn, Allentown, PA (US)

Correspondence Address: HITT GAINES & BOISBRUN P.C., P.O. BOX 832570, RICHARDSON, TX, 75083, US

(73) Assignee: Agere Systems Inc., Allentown, PA

(21) Appl. No.: 10/028,896

(22) Filed: Dec. 20, 2001

(51) Int. Cl. G02B 6/35

(52) U.S. Cl. 385/18

(57) ABSTRACT

The present invention provides an optical switch, a method of use thereof, and an optical communications system including the same. The optical switch may include a first substrate having an input mirror located thereon and a second substrate having an output mirror located thereon, wherein the second substrate is substantially parallel with the first substrate. In an advantageous embodiment, the optical switch may further include a retro-reflector located adjacent the first and second substrates and configured to redirect radiation from the input mirror to the output mirror.

### TECHNICAL FIELD OF THE INVENTION

The present invention is directed, in general, to an optical switch and, more specifically, to an optical switch having a retro-reflector, a method of use thereof, and an optical communications system including the same.

### BACKGROUND OF THE INVENTION

optical switches are currently gaining widespread use in today's ever competitive optical communications markets. One particular optical switch that is quickly gaining widespread use is an all-optical switch. All-optical switches provide certain benefits that may not be provided in many electronic switches, and as such, all-optical switches are very desirable.

All-optical switches currently use several methods to switch optical signals from one optical waveguide to another. Most of these methods include the use of mirrors. One notable design uses silicon processing to create movable “pop-up” mirrors on the surface of a silicon wafer. This design can be used to route radiation within a single plane. Using this design, one mirror is required for each connection. For example, if the all-optical switch connects n inputs to n outputs, then n² mirrors would be required. Because of limitations on the size of the mirrors and the processing involved, the area of the chip or wafer on which the mirrors are micro-machined is extremely large, and therefore, limits the expandability of the pop-up mirror switches.

Another notable design uses beam steering mirrors that rotate on two axes. Because the beam steering mirrors rotate on two axises, a reduced number of mirrors may be used to switch the same number of waveguides. For example, if a switch having beam steering mirrors connects n inputs to n outputs, then 2n beam steering mirrors might be required. While a smaller number of beam steering mirrors might be required to switch the same number of inputs and outputs, each individual beam steering mirror requires more chip or wafer area than a single pop-up mirror. As such, chip or wafer area problems still exist when using the beam steering mirrors. Additionally, the beam steering mirrors tend to be more difficult to assemble than pop-up mirrors.

Accordingly, what is needed in the art is an optical switch and a method of manufacture therefor, that does not experience the problems experienced by the prior art optical switches.

### SUMMARY OF THE INVENTION

To address the above-discussed deficiencies of the prior art, the present invention provides an optical switch, a method of use thereof, and an optical communications system including the same. The optical switch may include a first substrate having an input mirror located thereon and a second substrate having an output mirror located thereon, wherein the second substrate is substantially parallel with the first substrate. In an advantageous embodiment, the optical switch may further include a retro-reflector located adjacent the first and second substrates and configured to redirect radiation from the input mirror to the output mirror.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a cross-sectional view of an optical switch, which has been constructed according to the principles of the present invention;

FIG. 2 illustrates a plan view of the optical switch depicted in FIG. 1;

FIG. 3 illustrates a cross-sectional view of an alternative embodiment of an optical switch, which has been constructed in accordance with the principles of the present invention;

FIG. 4 illustrates an optical communications system, which may form one environment where an optical switch, similar to the optical switch shown in FIG. 1, may be included; and

FIG. 5 illustrates an alternative optical communications system.

### DETAILED DESCRIPTION

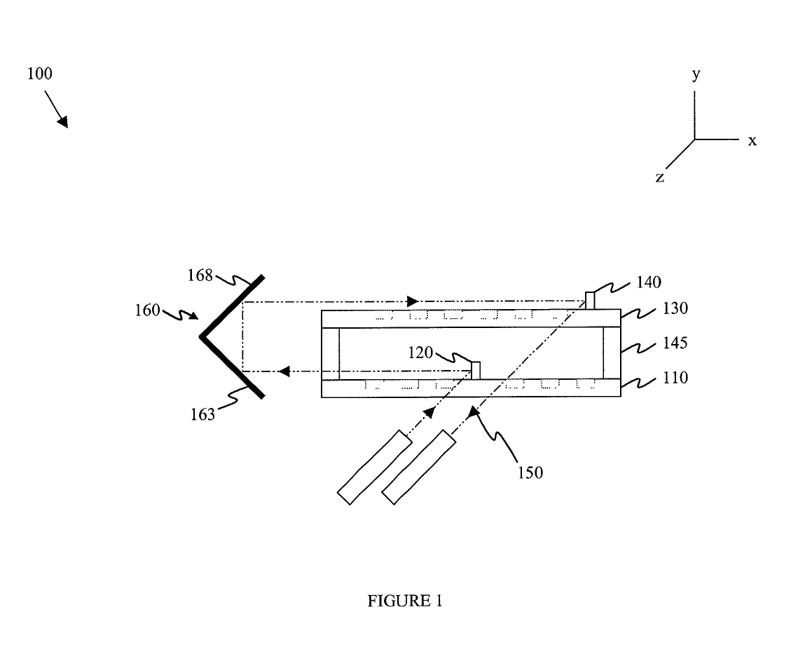

Referring initially to FIG. 1, illustrated is a cross-sectional view of an optical switch 100, which has been constructed according to the principles of the present invention. In the illustrative embodiment shown in FIG. 1, the optical switch 100 includes a first substrate 110 having an input mirror 120 located thereon. The first substrate 110 may encompass various embodiments, including a conventional silicon wafer having a plurality of input mirrors located thereon. For example, in one exemplary embodiment, the first substrate 110 is a conventional 1-Dimensional “pop-up” mirror wafer having a plurality of micro-electro-mechanical system (MEMS) mirrors located thereon.

Positioned over the first substrate 110 may be a second substrate 130. In one particularly advantageous embodiment, the second substrate 130 has an output mirror 140 located thereon. Additionally, the second substrate 130 may be positioned such that it is substantially parallel to the first substrate 120. The second substrate 130, similar to the first substrate 110 discussed above, may further include a plurality of output mirrors.

It should be noted that while the two substrates 110, 130 are being referred to as “first” and “second” substrates, any term may be used to differentiate the two. It should also be noted that where the first and second substrates 110, 130 are referred to as having “input” and “output” mirrors, respectively, the terms can be used interchangeably. For instance, in certain situations the input mirror 120 of the first substrate 110 may be acting as an output mirror, and the output mirror 140 of the second substrate 130 may be acting as an input mirror.

The first and second substrates 110, 130, may be separated from one another using spacers 145. For example, if the first and second substrates 110, 130 are stacked over one another, the spacers 145 may be required. In the illustrative embodiment shown in FIG. 1, the spacers 145 comprise a transparent material, such that they do not interfere with radiation 150 traveling within the optical switch 100. In an alternative embodiment, however, the spacers 145 are precisely positioned such that they have substantially no effect on the radiation 150. Nonetheless, one skilled in the art understands the various material compositions and locations of the spacers 145, as well as various methods of manufacture of the spacers 145, all of which may accomplish the objectives mentioned above.

Located adjacent the first and second mirrors 120, 140, in the illustrative embodiment shown in FIG. 1, is a retro-reflector 160. As illustrated, the retro-reflector 160 is configured to redirect the radiation 150 from the input mirror 120 to the output mirror 140. Alternatively, the retro-reflector 160 may be used to redirect the radiation 150 from any of the plurality of input mirrors on the first substrate 110 to any of the plurality of output mirrors on the second substrate 130, or vice versa.

The retro-reflector 160 may comprise many different structures. In one particular embodiment, the retro-reflector 160 comprises two substantially perpendicular surfaces 163, 168, wherein an inner surface of each of the perpendicular surfaces 163, 168, has a reflective coating located thereon. The term “substantially perpendicular” means that the two surfaces 163, 168 intersect one another at about a 90° angle. While the present invention focuses on the fact that the two surfaces 163, 168 intersect one another at about a 90° angle, other angles, if used in conjunction with correctly positioned first and second substrates 110, 130, may be within the scope of the present invention.

In an alternative embodiment, however, the retro-reflector 160 may comprise a cone or a corner cube (e.g., a 3-dimensional retro-reflector) having a reflective coating on an inner surface thereof. The cone, similar to the perpendicular surfaces 163, 168 discussed above, may be formed such that any two opposing surfaces are substantially perpendicular to one another. For example, in an exemplary embodiment a right isosceles circular cone may be used. By using a cone or the corner cube rather than the perpendicular surfaces 163, 168 discussed above, a larger range of switching alternatives may be obtained.

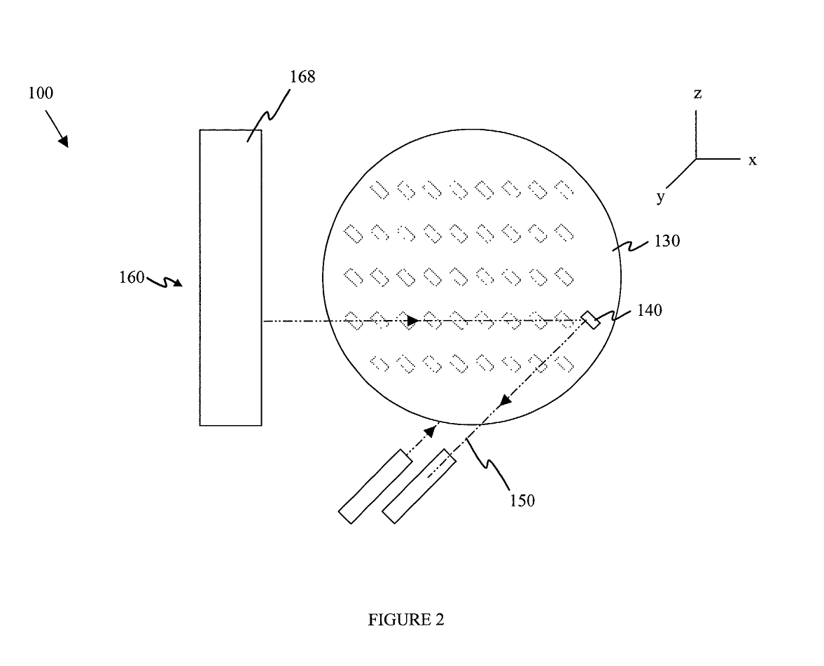

Turning to FIG. 2, illustrated is a plan view of the optical switch 100 depicted in FIG. 1. The plan view illustrated in FIG. 2 shows the second substrate 130 having the output mirror 140 located thereon, the radiation 150, and the retro-reflector 160. Because the second substrate 130 is located directly over the first substrate 110 in this particular embodiment, the first substrate 110 can not be viewed.

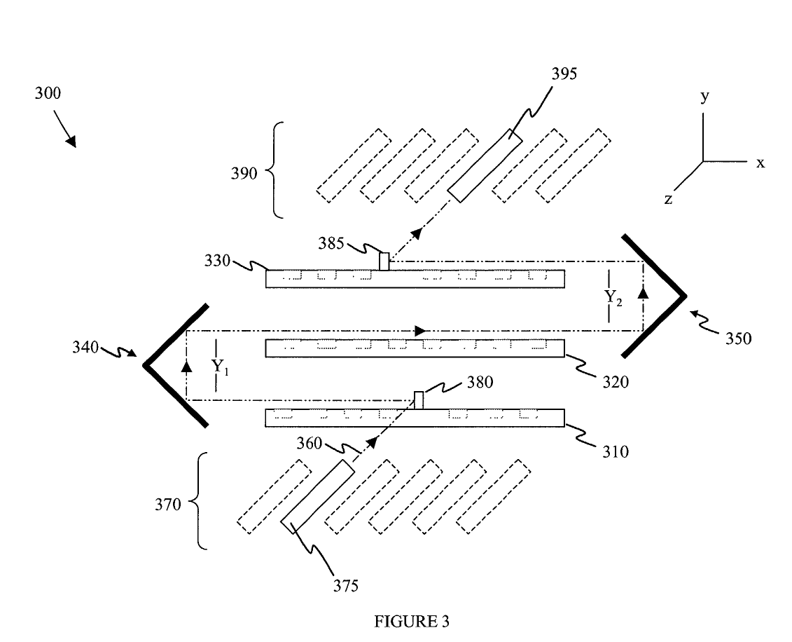

Turning to FIG. 3, illustrated is a cross-sectional view of an alternative embodiment of an optical switch 300, which has been constructed in accordance with the principles of the present invention. The optical switch 300 includes a first substrate 310, a second substrate 320, and a third substrate 330. The first, second and third substrates 310, 320, 330 may be substantially similar to the first and second substrates 110, 130 shown and discussed with respect to FIG. 1.

The optical switch 300 may further include a first retro-reflector 340 located adjacent the first and second substrates 310, 320, and a second retro-reflector 350 located adjacent the second and third substrates 320, 330. The first and second retro-reflectors 340, 350 may be similar to the retro-reflector 160 shown and described with respect to FIG. 1. As illustrated, any two retro-reflectors shared by a single substrate should generally be located across from one another. For example, in the illustrative embodiment shown in FIG. 3, the first and second retro-reflectors 340, 350 share the second substrate 320, and therefore, should be located across from one another.

Each of the first, second and third substrates 310, 320, 330 includes a plurality of input/output mirrors that are configured to redirect radiation between the various substrates 310, 320, 330. It should be noted that while the embodiment illustrated in FIG. 3, shows only three substrates 310, 320, 330 and only two retro-reflectors 340, 350, any number of substrates and retro-reflectors are within the scope of the present invention. In an exemplary embodiment, however, n number of substrates would require (n-1) number of retro-reflectors for increased switching capabilities.

A method of operating the optical switch 300 illustrated in FIG. 3, will now be discussed. It should be noted again, that while the following method of operating the optical switch 300 will be referring to input and output waveguides and mirrors, whether a waveguide or mirror is designated as an input or an output depends solely on the direction the radiation is traveling. Thus, the designation only indicates how a waveguide or mirror is acting at one particular instance, and should not be used to restrict a specific waveguide or mirror to being only an input or output waveguide or mirror.

In the particular embodiment illustrated in FIG. 3, radiation 360 exits an output waveguide 375. The output waveguide 375 is one of a plurality of waveguides 370 located proximate and on substantially the same plane as the first substrate 310. In the current example, the radiation 360 exits the output waveguide 375, and travels along a path parallel with a surface of the first substrate 310, until it encounters an input mirror 380. Because the input mirror 380 is actuated (“popped up”), and a remainder of the input/output mirrors on the surface of the first substrate 310 are not actuated, the radiation encounters the input mirror 380 and is redirected toward the first retro-reflector 340. It should be understood that while the input mirror 380 is configured to redirect the radiation 360 toward the first retro-reflector 340, any of the plurality of input/output mirrors may be configured (e.g., by changing an angle of the plurality of input/output mirrors) to redirect the radiation to any desired location.

As the radiation 360 encounters the first retro-reflector 340, the radiation 360 is reflected along a plane parallel with a plane of which the radiation 360 encountered the first retro-reflector 340, however, displaced by a distance Y₁. As illustrated in the exemplary embodiment shown in FIG. 3, the radiation 360 is also redirected in a plane that is parallel with the second substrate 320.

If none of the input/output mirrors located on the second substrate 320 are actuated, such as illustrated, the radiation 360 travels over the surface of the second substrate 320 until it encounters the second retro-reflector 350. If one of the input/output mirrors located on the second substrate 320 is actuated, the radiation 360 may be reflected to a different input/output waveguide (not shown) which is located on substantially the same plane as the second substrate 320. This would result in a switch of the radiation 360 from the output waveguide 375 to a different waveguide. In an alternative embodiment, however, the radiation could be redirected back to the first substrate 310 through the first retro-reflector 340, and thus, be switched to the same output waveguide 375, or one of the plurality of input/output waveguides 370 located on substantially the same plane as the first substrate 310.

As illustrated, however, none of the input/output mirrors located on the second substrate 320 are actuated, and the radiation 360 travels parallel with the second substrate 320 until it encounters the second retro-reflector 350. The second retro-reflector 350 then reflects the radiation 360 along a plane parallel with a plane of which the radiation encountered the second retro-reflector 350, however, at a displaced distance of Y₂. In an exemplary embodiment, the displaced distance Y₂ is substantially similar to the displaced distance Y₁. As illustrated in the exemplary embodiment shown in FIG. 3, the radiation 360 is also redirected in a plane that is parallel with the third substrate 330. The displacement distances Y₁, Y₂ created by the first and second retro-reflectors 340, 350 helps determine a distance desired between the first, second and third substrates 310, 320, 330. As such, careful attention should be taken during manufacturing the optical switch 300.

The radiation 360 then travels over the third substrate 330 until it encounters an actuated output mirror 385. The output mirror 385 may then redirect the radiation 360 to an input waveguide 395, which is one of a plurality of input waveguides 390 located proximate and on substantially the same plane as the third substrate 330. Thus, in the current example, the radiation 360 is switched from the output waveguide 375 to the input waveguide 395. In an alternative embodiment, however, the radiation 360 could be reflected back to the second retro-reflector 350.

While the previously discussed method of operating the optical switch 300 has only given one particular switching configuration and radiation path, it should be noted that the various input/output mirrors on the various substrates may be tilted and actuated in any fashion to switch radiation from any one waveguide located proximate the optical switch 300 to any other waveguide located proximate the optical switch 300. Additionally, it should be noted that while the view shown in FIG. 3 is a cross-sectional view and only illustrates input/output mirrors located at that cross-section, various other input/output mirrors may be located into or out of the page, therefore, many other input/output mirrors can also be used for switching.

An optical switch in accordance with the principles of the present invention provides many advantages. For example, the optical switch allows one to increase the number of connections that can be made on an existing all-optical cross-connect switch. Additionally, the optical switch may be easily manufactured using conventional methods and devices. For example, conventional pop-up mirror substrates and spacers may be used to manufacture the optical switch, with retro-reflectors being positioned adjacent the pairs of substrates to redirect the radiation between the pairs of substrates.

Another advantage includes the ability to add any number of substrates and retro-ref lectors, such that radiation can be routed to and from multiple planes of arrayed pop-up mirrors for dramatically increased expandability. Additionally, the optical device is modular, which enables control of yield on a sub-system level. The optical switch also allows for two-way traffic of radiation from one substrate to another. Also, when manufacturing, an angle of the substrates relative to the various retro-reflectors is not critical because radiation entering the retro-reflectors will always be parallel with radiation exiting the retro-reflectors.

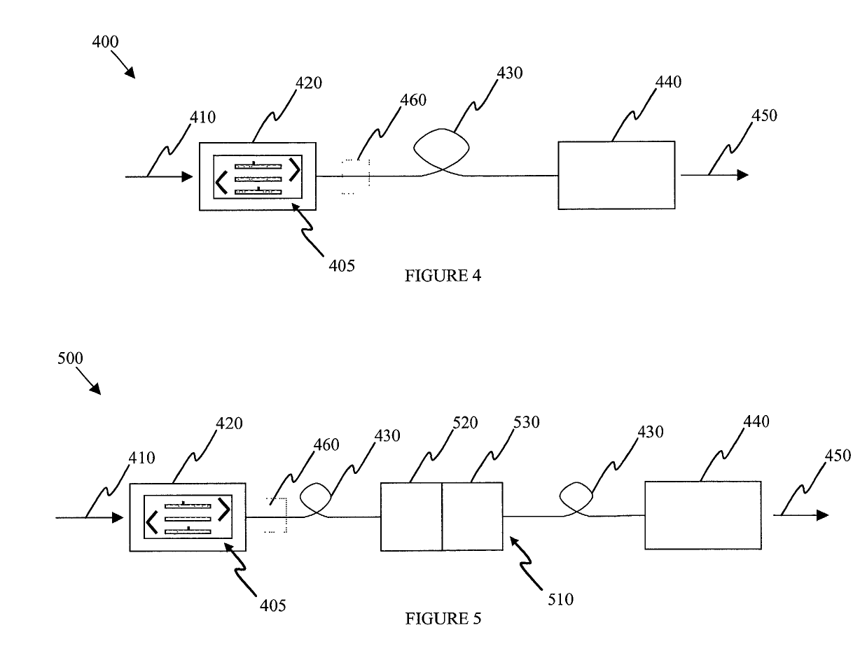

Turning briefly to FIG. 4, illustrated is an optical communications system 400, which may form one environment where an optical switch 405, similar to the optical switch 100 shown in FIG. 1, may be included. The optical communications system 400, in the illustrative embodiment, includes an initial signal 410 entering a receiver 420. The receiver 420, receives the initial signal 410, addresses the signal 410 in whatever fashion desired, and sends the resulting information across an optical fiber 430 (or plurality of fibers) to a transmitter 440. The transmitter 440 receives the information from the optical fiber 430, addresses the information in whatever fashion desired, and sends an ultimate signal 450. As illustrated in FIG. 4, the optical switch 405 may be included within the receiver 420. However, the optical switch 405 may also be included anywhere in the optical communications system 400, including the transmitter 440. The optical communications system 400 is not limited to the devices previously mentioned. For example, the optical communications system 400 may include a source 460, such as a laser or a diode. The optical communications system 400 may further include various other lasers, photodetectors, optical amplifiers, transmitters, and receivers.

Turning briefly to FIG. 5, illustrated is an alternative optical communications system 500, having a repeater 510, including a second receiver 520 and a second transmitter 530, located between the receiver 420 and the transmitter 440.

Although the present invention has been described in detail, those skilled in the art should understand that they can make various changes, substitutions and alterations herein without departing from the spirit and scope of the invention in its broadest form.

What is claimed is:

1. An optical switch, comprising:
a first substrate having an input mirror located thereon;
a second substrate substantially parallel with the first substrate and having an output mirror located thereon; and
a retro-reflector located adjacent the first and second substrates and configured to redirect radiation from the input mirror to the output mirror.

2. The optical switch as recited in claim 1 wherein the input mirror is a first input mirror and the output mirror is a first output mirror, and wherein the first and second substrates each further include a plurality of input mirrors and output mirrors.

3. The optical switch as recited in claim 1 wherein the input and output mirrors are micro-electro-mechanical system mirrors.

4. The optical switch as recited in claim 1 wherein the first and second substrates are stacked over one another.

5. The optical switch as recited in claim 1 wherein a spacer separates the first and second substrates from one another.

6. The optical switch as recited in claim 1 wherein the retro-reflector comprises two perpendicular reflective surfaces.

7. The optical switch as recited in claim 1 wherein the retro-reflector comprises a right isosceles circular cone or a corner cube having a reflective surface on an inner surface thereof.

8. The optical switch as recited in claim 1 further including a plurality of substrates located substantially parallel with the first substrate and second substrate and a plurality of retro-reflectors located adjacent the plurality of substrates.

9. A method of operating an optical switch, comprising:
projecting radiation from an output waveguide along a first substrate having an input mirror located thereon; and
actuating the input mirror to cause the radiation to be redirected toward a retro-reflector, wherein the retro-reflector redirects the radiation toward an input waveguide.

10. The method as recited in claim 9 wherein the retro-reflector redirects the radiation along a second substrate substantially parallel with the first substrate and having an output mirror located thereon, and further including actuating the output mirror to redirect the radiation toward the input waveguide.

11. The method as recited in claim 10 wherein the input waveguide is the output waveguide.

12. The method as recited in claim 9 wherein the retro-reflector is a first retro-reflector that redirects the radiation along a second substrate substantially parallel with the first substrate, and further including reflecting the redirected light traveling along the second substrate using a second retro-reflector, wherein the second retro-reflector redirects the radiation along a third substrate substantially parallel with the second substrate and having an output mirror located thereon, and further including actuating the output mirror to redirect the radiation toward the input waveguide.

13. The method as recited in claim 9 wherein actuating the input mirror includes applying a voltage to actuate a micro-electro-mechanical system mirror.

14. An optical communications system, comprising:
an optical switch, comprising;
a first substrate having an input mirror located thereon;
a second substrate substantially parallel with the first substrate and having an output mirror located thereon; and
a retro-reflector located adjacent the first and second substrates and configured to redirect radiation from the input mirror to the output mirror; and
a plurality of input and output waveguides optically coupled to the optical switch and configured to transmit radiation.

15. The optical communications system as recited in claim 14 wherein the first and second substrates are stacked over one another.

16. The optical communications system as recited in claim 14 further including a plurality of substrates located substantially parallel with the first substrate and second substrate and a plurality of retro-reflectors located adjacent the plurality of substrates.

17. The optical communications system as recited in claim 14 wherein the input mirror is a first input mirror and the output mirror is a first output mirror, and wherein the first and second substrates each further include a plurality of input mirrors and output mirrors.

18. The optical communications system as recited in claim 14 wherein the input and output mirrors are micro-electro-mechanical system mirrors.

19. The optical communications system as recited in claim 14 wherein a spacer separates the first and second substrates from one another.

20. The optical communications system as recited in claim 14 further including devices coupled to the optical switch that are selected from the group consisting of:
lasers,
photodetectors,
optical amplifiers,
transmitters, and
receivers.
